(19) United States
(12) Patent Application Publication
(10) Pub. No.: US 2014/0201040 A1
(43) Pub. Date: Jul. 17, 2014

(54) PRESENTATION-STRUCTURE-AWARE DISPLAY OF PLANOGRAMS

(71) Applicant: Thomas A. Birch, Portland, OR (US)

(72) Inventor: Thomas A. Birch, Portland, OR (US)

(21) Appl. No.: 13/997,638

(22) PCT Filed: Mar. 30, 2012
(86) PCT No.: PCT/US12/31652

§ 371 Date: Jun. 24, 2013

(51) Int. Cl. G06Q 10/08

(52) U.S. Cl. CPC G06Q 10/087
USPC 705/28

(57) ABSTRACT

Embodiments of techniques and systems for presentation-structure-aware (“PS-aware”) display of planograms are described. In embodiments, a PS-aware planogram display system may acquire an image of a presentation structure. The display system may, based at least in part on the acquired image, display a planogram of an intended preparation of items at the presentation structure. The display system may also analyze the acquired image for one or more markers which may identify the presentation structure. The display system may then identify the presentation structure and obtain a planogram. The display system may also modify the planogram based on an orientation and/or position of the acquired image. The modified planogram may be displayed in a partially-transparent manner placed on the acquired image for viewing by a user. Other embodiments may be described and claimed.

### FIELD

Embodiments of the present invention relate generally to the technical field of data processing, and more particularly, to presentation-structure-aware display of planograms.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Retailers often may make arrangements with product producers involving specific placement of products on presentation structures, such as retail shelving. For example, a grocery store owner may make an agreement whereby a particular soup manufacturer pays for the privilege of having their soups being displayed to shoppers on an eye-level shelf. However, because there are often many products and manufacturers represented in a given space, the retailers, may have to satisfy many different shelving arrangements simultaneously, resulting in complex interactions between the products. Often, retailers may use charts called “planograms,” which provide a visual representation of placement of products, to more easily satisfy these arrangements. The planograms, which may be generated by various means, may be based on the various arrangements and agreements the retailer has entered into.

However, it can be difficult for retailers and/or their employees to make easy use of the planograms. Printed planograms can be difficult for an employee to compare to real-life presentation structures. Further, even when electronic means are used to provide planogram information, these electronic means may still only provide-static displays of the planograms. Once again, an employee may find it difficult to use this static information when stocking real-life presentation structures with products.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example presentation-structure-aware planogram display system, in accordance with various embodiments.

FIG. 2 illustrates an example presentation-structure-aware planogram display process, in accordance with various embodiments.

FIG. 3 illustrates an example planogram preparation process, in accordance with various embodiments.

FIG. 4 illustrates an example planogram display process, in accordance with various embodiments.

FIG. 5 illustrates an example usage of the presentation-structure-aware planogram display system, in accordance with various embodiments.

FIG. 6 illustrates an example image acquired by the presentation-structure-aware planogram display system, in accordance with various embodiments.

FIG. 7 illustrates an example planogram displayed by the presentation-structure-aware planogram display system, in accordance with various embodiments.

FIG. 8 illustrates a display of a planogram and an acquired image by the presentation-structure-aware planogram display system, in accordance with various embodiments.

FIG. 9 illustrates an example computing environment suitable for practicing the disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

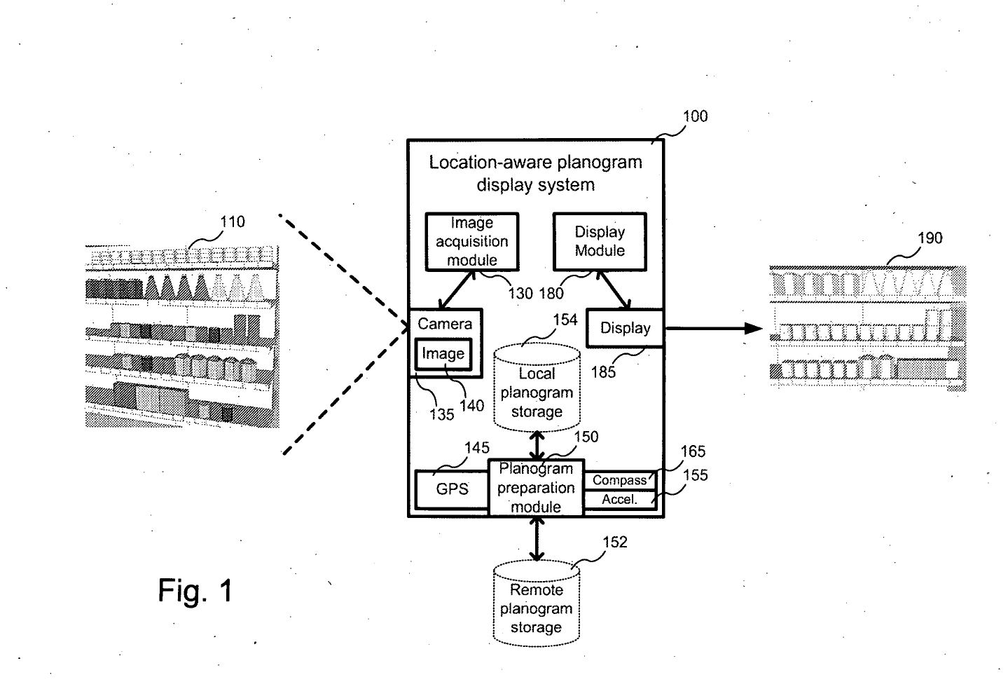

Referring now to FIG. 1, a presentation-structure-aware (“PS-aware”) planogram display system 100 is illustrated. In various embodiments, the PS-aware planogram display system 100 may be configured to acquire an image of a presentation structure, such as a shelf where products may be displayed, and to display a planogram showing a presentation of an intended presentation of products at the presentation structure. In various embodiments, the PS-aware planogram display system 100 may identify the presentation structure by analyzing the acquired image to analyze visible markers on the presentation structure. In various embodiments, the PS-aware planogram display system 100 may determine an orientation and/or position information for the system based on these markers and/or on data received from other sensors, such as GPS receivers, accelerometers, and/or compasses. The PS-aware planogram display system 100 may then, in various embodiments, use this data to modify the planogram based on the determined orientation and/or position.

In various embodiments, the PS-aware planogram display system 100 may display the planogram as so modified. By doing so the PS-aware planogram display system 100 may show the planogram oriented in a similar fashion to the presentation display itself; this may facilitate users of the PS-aware planogram display system 100 in understanding information contained in the planogram, and in placing products on the presentation structure accordingly. In addition, in various embodiments, the PS-aware planogram display system 100 may also display the planogram in a partially-transparent form overlaid on top of the image acquired by the PS-aware planogram display system 100. By overlaying the two images, the PS-aware planogram display system 100 may provide the planogram in an augmented-reality style so a user may more easily understand the product placement information contained in the planogram. Particular examples of these embodiments are described herein.

As illustrated in FIG. 1, the PS-aware planogram display system 100 may, in various embodiments, include a camera 135 and a display 185. In various embodiments, the PS-aware planogram display system 100 may include, but is not limited to, a tablet computing device. In various embodiments, the camera 135 may be placed on a side of the tablet computing device opposite that of the display 185. In various embodiments, the camera 135 may include a built-in camera or, alternatively, a separate camera in communication with the PS-aware planogram display system 100. In various embodiments, the display 185 may include a screen or, alternatively, a separate display in communication with the PS-aware planogram display system 100. In other embodiments, other devices and arrangements of cameras and displays may be used.

In various embodiments, the camera 135 may be configured to acquire images, such as image 140. In particular, in embodiments, the camera 135 may be used to acquire images of presentation displays arranged on a presentation structure 110. In other embodiments, the camera 135 may be used to acquire only the presentation structure 110 without any presentation display arranged thereon. In various embodiments, the PS-aware planogram display system 100 may include an image acquisition module 130. In embodiments, the image acquisition module 130 may be configured to control the camera 135 to acquire one or more the images 140 of the presentation display and/or presentation structure 110.

In various embodiments, the presentation structure 110 may include one or more shelves upon which products may be arranged to form a presentation display; in other embodiments, the presentation structure 110 may include, for example, tables, wall displays, and/or other structures. In some embodiments, products may be currently presented on the presentation structure 110 at the time the image 140 is acquired; in other embodiments, the presentation structure 110 may be empty. In various embodiments the presentation structure 110 may include one or more markers; in various embodiments, the markers may be visible in the acquired image 140. The markers may be used, in various embodiments, to identify the presentation structure 110 and/or its location through an analysis of markers that are visible in the image 140. In various embodiments, the markers may include one or more implementation of micro digital signage (“MDS”).

As illustrated in FIG. 1, in various embodiments, the PS-aware planogram display system 100 may include a display module 180. In various embodiments, the display module 180 may be configured to display a planogram 190 on the display 185. In various embodiments, the display module may also be configured to display a partially-transparent version of the planogram 190 placed on the acquired image 140. As discussed above, by overlaying the planogram 190 on the acquired image 140, in various embodiments, the display module 180 may present the planogram 190 in a form that is easier for a user to understand and to use for placing products on the presentation structure 110.

As illustrated in FIG. 1, in various embodiments, the PS-aware planogram display system 100 may include a planogram preparation module 150. In various embodiments, the planogram preparation module 150 may be configured to select the planogram 190 for display by the display module 180 on the display 185. In various embodiments, the planogram preparation module 150 may be configured to obtain the selected planogram 190 from remote storage, such as remote planogram storage 152. Thus, in such embodiments, the PS-aware planogram display system 100 may be in communication, such as via a wired or wireless communication network, to request and download planogram data and/or planograms from the remote planogram storage 152. In alternative embodiments, the planogram preparation module 150 may be configured to obtain the selected planogram 190 from planogram storage stored locally on the PS-aware planogram display system 100, such as local planogram storage 154. In various embodiments, the PS-aware planogram display system 100 may be configured as well to obtain one or more planograms and/or planogram data from remote planogram storage 152 and to store the one or more planograms and/or planogram data on the local planogram storage 154. In alternative embodiments, the PS-aware planogram display system 100 may be configured to have one or more planograms and/or planogram data stored on the local planogram storage 154 prior to usage of the PS-aware planogram display system 100.

In various embodiments, the planogram preparation module 150 may also be configured to determine an orientation and/or position of the acquired image relative to the PS-aware planogram display system 100. In various embodiments, the planogram preparation module may be configured to determine the orientation and/or position of the acquired image based on data received from one or more orientation and/or position sensors. Thus, as illustrated in FIG. 1, in various embodiments, the PS-aware planogram display system 100 may include orientation and/or position sensors, such as a Global Positioning System (“GPS”) sensor 145, an accelerometer 155 and/or a compass 165, one or more of which may be in communication with the planogram preparation module. Additionally, in various embodiments, the planogram preparation module may be configured to determine orientation and/or position of the acquired image 140 through an analysis of one or more of the markers attached to the presentation structure 110 that are visible in the acquired image 140.

In various embodiments, the planogram presentation module 150 may also be configured to modify the planogram 190 based on the determined position and/or orientation of the acquired image. In various embodiments, the planogram presentation module 150 may be configured to modify the planogram 190 based on the determined position and/or orientation so that, when displayed, the planogram 190 may be oriented to a user as if the user were viewing the presentation structure 110 through the display 185 as if the display were transparent, only with products displayed on the presentation structure 110 as represented in the planogram 190. In various embodiments, by modifying the planogram 190, a user of the PS-aware planogram display system 100 may be better able to understand the information displayed in the planogram relative to the presentation structure 110, and thus make better use of the information.

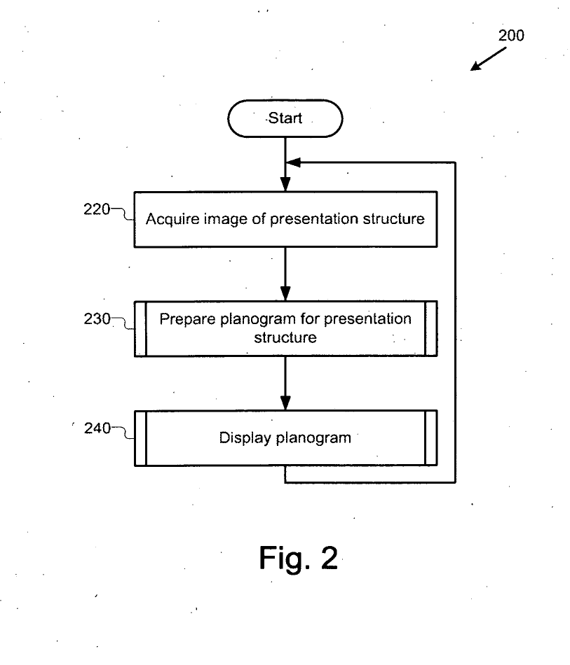

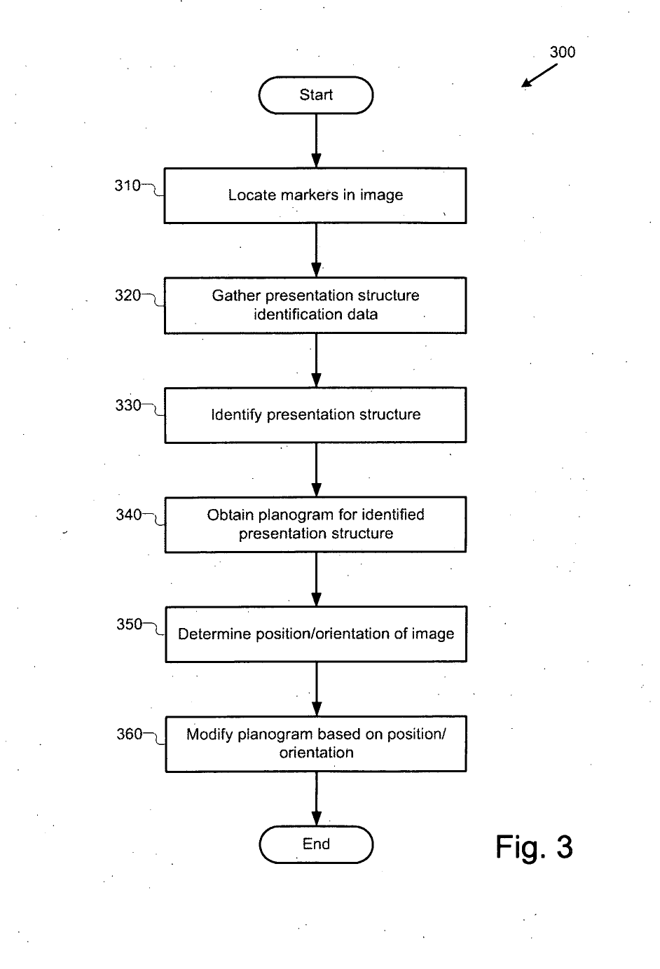

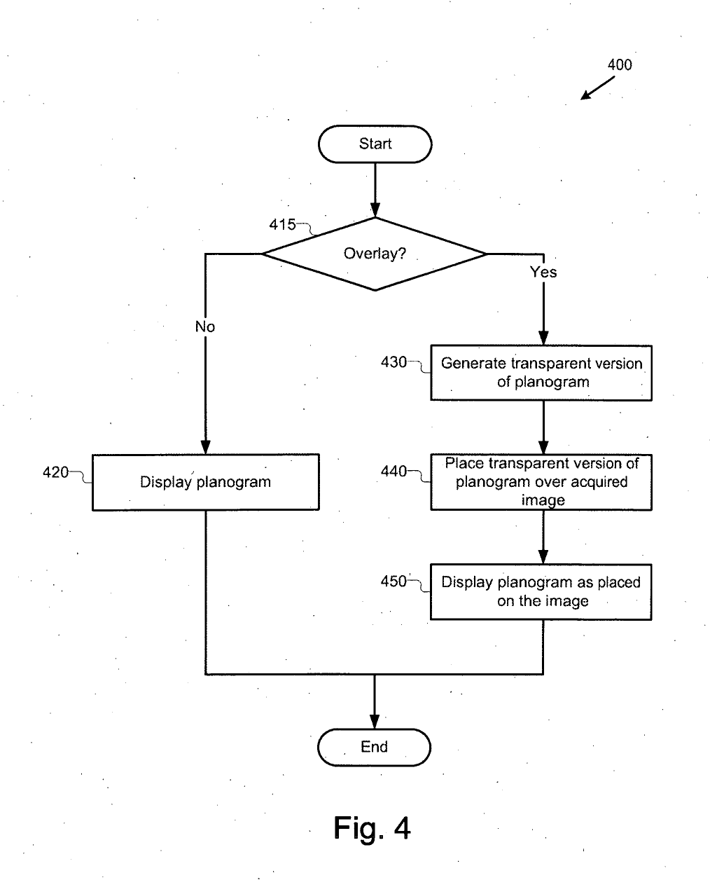

FIG. 2 illustrates an example PS-aware planogram display process 200, in accordance with various embodiments. The process may begin at operation 220, where the image acquisition module 130 of the PS-aware planogram display system 100 may control the camera 135 to acquire an image 140 of the presentation structure 110. In various embodiments, the image acquisition module 130 may repeatedly control the camera 135 to acquire multiple images, such as by taking multiple still images or by taking video using the camera 140. Next, at operation 230, the planogram presentation module 150 of the PS-aware planogram display system 100 may prepare the planogram 190 for the presentation structure 110. Particular examples of implementations of operation 230 are described below with reference to FIG. 3. At operation 240, the display module 180 may display the prepared planogram 190 on the display 185. Particular examples of implementations of operation 240 are described below with reference to FIG. 4. Process 200 may then repeat to acquire new images, and prepare and display planograms, such as by returning to operation 220. In various embodiments, by repeating process 200, the PS-aware planogram display system 100 may continuously update the display of the PS-aware planogram display system 100 as it is moved and used by a user.

FIG. 3 illustrates an example planogram preparation process 300, in accordance with various embodiments. In various embodiments, process 300 may be performed by the planogram preparation module 150 of the PS-aware planogram display system 100 as an implementation of operation 230 of process 200. The process may begin at operation 310, where the planogram presentation module 150 may locate one or more markers that are visible in the acquired image 140. As discussed above, in various embodiments, the markers may include be various implementations of MDS that are attached to the presentation structure 110 that is captured in the acquired image. Next, at operation 320, the planogram presentation module 150 may gather data through which it may identify the presentation structure 110 captured in the acquired image 140. In various embodiments, the planogram presentation module 150 may gather information encoded on the one or more markers located in the acquired image 140. In other embodiments, the planogram presentation module 150 may receive data from position and/or orientation sensors present in the PS-aware planogram display system 100, such as the GPS 145, accelerometer 155 and/or the compass 165, to determine position and/or orientation information for the PS-aware planogram display system 100. In other embodiments, other information, such as wireless network connectivity or user-input data, may be gathered. In various embodiments, all or part of this information may be combined to provide a more detailed picture of the identification of the presentation structure 110 captured in the acquired image 140.

Next, at operation 330, the planogram preparation module 150 may identify the presentation structure 110 that was captured in the acquired image 140. In various embodiments, the planogram preparation module 150 may identify the presentation structure 110 by using all or part of the data gathered in operation 320 to look up the identity of the presentation structure 110 in a local database or other storage (such, as for example, local planogram storage 154). In other embodiments, the planogram preparation module 150 may identify the presentation structure 110 by using all or part of the data gathered in operation 320 to look up the identity of the presentation structure 110 in a remote database or other storage (such as, for example, local planogram storage 152).

Next, at operation 340, the planogram presentation module 150 may obtain the planogram 190 for the identified presentation structure. In various embodiments, at operation 340 the planogram presentation module 150 may look up the planogram 190 in either the local planogram storage 154 or the remote planogram storage 152 based on the identity of the presentation structure 110 determined at operation 330. In various embodiments, the planogram 190 may be obtained in whole form from the local or remote storage. In alternative embodiments, however, the planogram presentation module 150 may obtain planogram data from the local or remote storage and may itself generate a planogram from the obtained data. In various embodiments, the obtained planogram 190 may include a representation of the presentation structure 110, as well as one or more representations of products that are placed on the presentation structure 110.

Next, at operation 350, the planogram presentation module 150 may determine the position and/or orientation of the acquired image 140 relative to the PS-aware planogram display system 100. In various embodiments, as discussed above, the planogram presentation module 150 may gather information to determine the position and/or orientation based on data received from position and/or orientation sensors present in the PS-aware planogram display system 100, such as the GPS 145, accelerometer 155 and/or the compass 165. Next, at operation 360, the planogram presentation module 360 may modify the planogram 190 obtained at operation 340 based on the determined position and/or orientation. In various embodiments, the planogram presentation module 150 may modify the planogram 190 based on the position and/or orientation so that, when a user later views the displayed planogram 190 on the display 185, the planogram 190 is oriented as if the user were viewing the presentation structure 110 through the display 185, only with products displayed on the presentation structure 110 as represented in the planogram 190. Thus, though this modification, the user may be presented with a version of the planogram 190 which is much truer-to-life than an unmodified version of the planogram 190. In various embodiments, the planogram presentation module 150 may be configured to modify the planogram 190 by performing various modifications, such as, for example, translating, skewing, rotating, and/or scaling the obtained planogram 190. This modified planogram 190 may then be displayed by the PS-aware planogram display system 100, such as at operation 240 of process 200. Process 300 may then end.

FIG. 4 illustrates an example planogram display process 400, in accordance with various embodiments. In various embodiments, process 400 may be performed by the display module 180 of the PS-aware planogram display system 100 as an implementation of operation 240 of process 200. The process may begin at decision operation 415, where the display module 150 may determine whether the planogram 190 is to be overlaid over the acquired image 140. In some embodiments, the display module 180 may perform this determination based on user preferences. If the display module determines that the planogram 190 is not to be overlaid on the acquired image 140, then at operation 420, the display module may display the planogram, such as on display 185. If, however, the display module determines that the planogram 190 is to be overlaid on the acquired image 140, then at operation 430 the display module may generate a transparent version of the planogram 190. Next, at operation 440, the display module 180 may place the transparent version of the planogram 190 on the acquired image 140. In various embodiments, because the planogram 190 may have been modified during process 300 based on the position and/or orientation of the acquired image 140, the transparent version of the 190 may match up with relative fidelity to the acquired image 140 when placed on the acquired image 140, providing a user with a relatively understandable overlay of planogram information on the real-life acquired image 140. Then, at operation 450, the display module 180 may display the planogram as placed on the image. The process may then end.

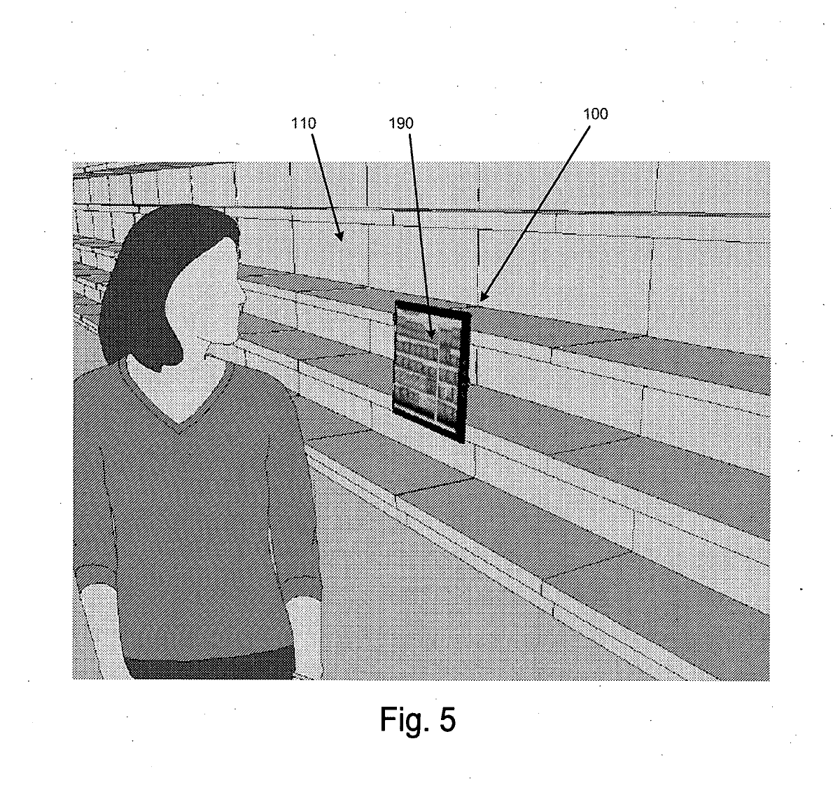

FIG. 5 illustrates an example usage of the PS-aware planogram display system 100, in accordance with various embodiments. In the example, the PS-aware planogram display system 100 is oriented so that a camera 135 of the PS-aware planogram display system 100 is acquiring images of presentation structure 110. Based on the image 140 that the PS-aware planogram display system 100 has acquired of the presentation structure 110, the PS-aware planogram display system 100 is displaying a planogram 190 for the presentation structure 110. It may be noticed that, while the presentation structure 110 illustrated in FIG. 5 does not have any products on it, the displayed planogram 190 includes a representation of the presentation structure 110 including representations of various products.

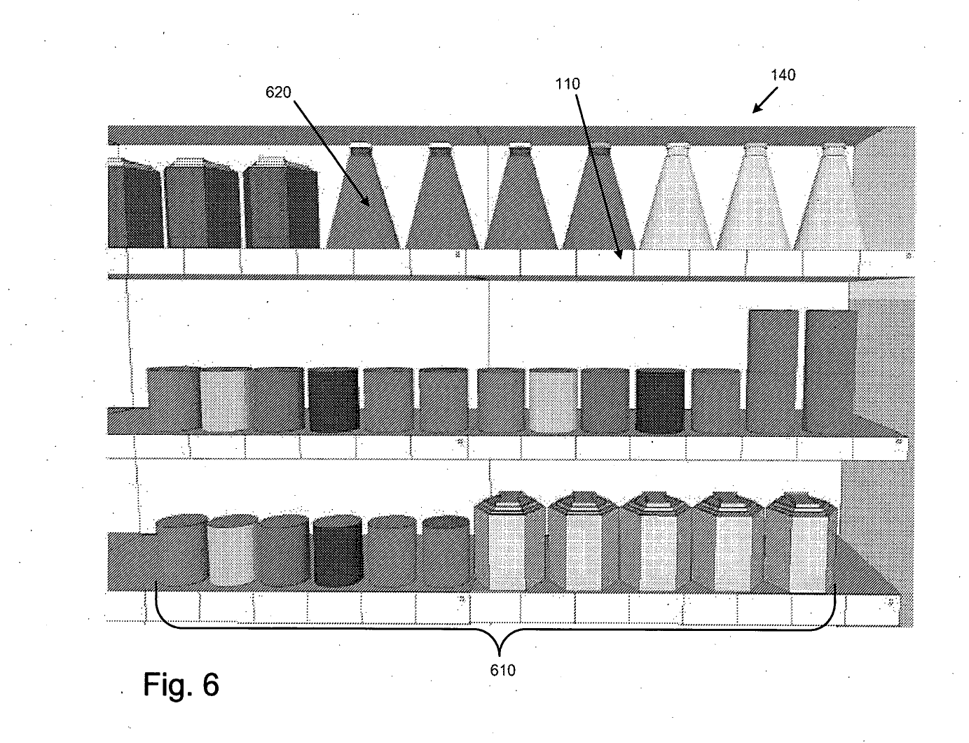

FIGS. 6-8 illustrate examples of the planogram 190 and acquired image 140 in accordance with various embodiments. In FIG. 6, an example acquired image 140 is shown. In the example, the acquired image contains an image of the presentation structure 110, as well as various products, such as products 610, that were presented on the presentation structure 110 at the time that the acquired image 140 was acquired.

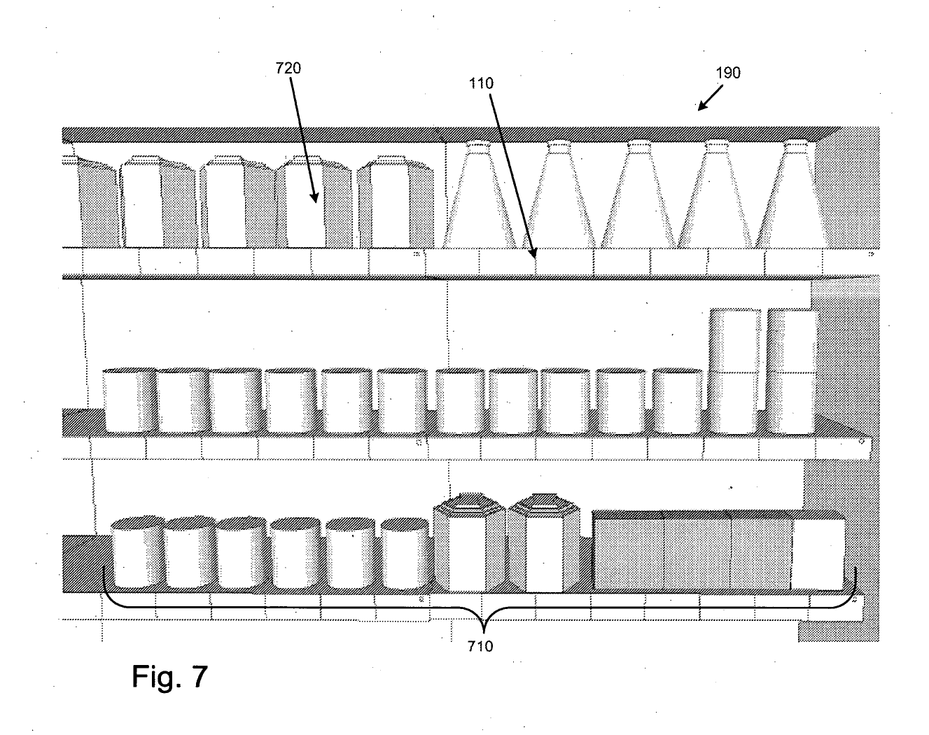

By contrast, FIG. 7 shows an example planogram 190 for the presentation structure 110, displayed according to various embodiments described herein. As illustrated in FIG. 7, in various embodiments, the planogram 190 may include a representation of one or more products on a representation of the presentation structure 110, such as representation of products 710. However, in various examples, planogram 190 may include a placement of a product on the presentation structure 110 that differs from the real-world current placement of products on the presentation structure 110 that was captured in the acquired image 140. For example, planogram 190 includes product representation 720, which has a canister shape. This differs from actual product 620 illustrated in FIG. 6, which has a cone shape. By comparing the displayed product representation 720 to the actual product 620, a user may be able to see that products are placed on the presentation structure 110 in a placement other than that described by the planogram 190.

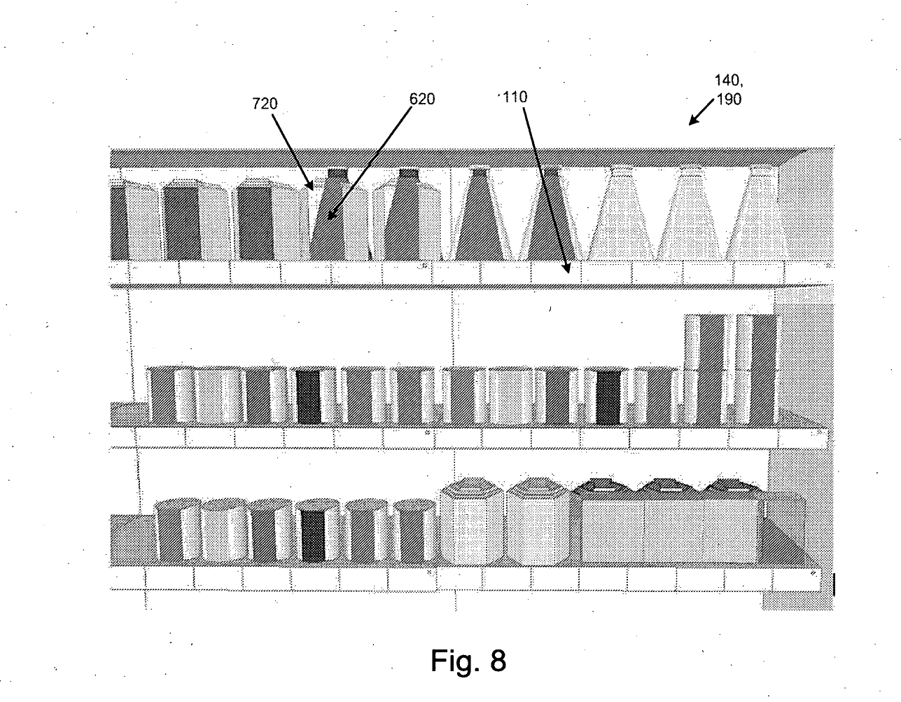

FIG. 8 illustrates an example of the planogram 190 placed on the acquired image 140 that helps a user make this distinction. In FIG. 8, the planogram 190 and acquired image 140 are illustrated as displayed together in accordance with various embodiments. As illustrated, in various embodiments, the planogram 190 may be displayed in a partially transparent version and placed over the acquired image 140 so, that information from both may be seen simultaneously. Additionally, in various embodiments, the planogram 190 may be modified based on the orientation and position of the acquired image 140 so that products match up between the acquired image 140 and the planogram 190. Thus, as illustrated, the product 620 that is currently presented on the presentation structure 110 is displayed beneath a transparent version of the product representation 720. A user, using the PS-aware planogram display system 100 according to various embodiments, may therefore see the discrepancy between the product 620 and the product representation 720 more easily and may correct the display on the actual presentation structure 110.

Referring back to FIG. 1, the techniques and apparatuses described herein may be implemented into a system using suitable hardware and/or software to configure as desired. In embodiments, image acquisition module 130, planogram presentation module 150, and/or display module 180 may be implemented using Application Specific Integrated Circuit (ASIC) or programmable integrated circuits, e.g., Field Programmable Gate Arrays (FPGA). In other embodiments, image acquisition module 130, planogram presentation module 150, and/or display module 180 may be implemented in software and/or firmware executed by one or more processors (each having one or more processor cores). In embodiments, image acquisition module 130, planogram presentation module 150, and/or display module 180 may be combined or have their functions further distributed into additional modules.

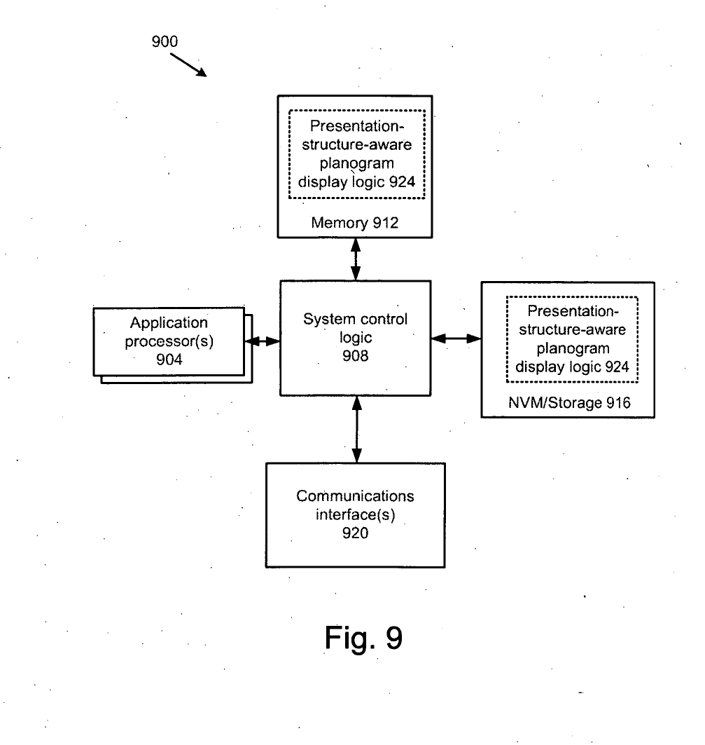

FIG. 9 illustrates, for one embodiment, an example computer system 900 suitable for practicing software/firmware implemented embodiments of the present disclosure. As illustrated, example computer system 900 may include control logic 908 coupled to at least one of the processor(s) 904, system memory 912 coupled to system control logic 908, non-volatile memory (NVM)/storage 916 coupled to system control logic 908, and one or more communications interface(s) 920 coupled to system control logic 908. In various embodiments, the one or more processors 904 may be a processor core.

System control logic 908 for one embodiment may include any suitable interface controllers to provide for any suitable interface to at least one of the processor(s) 904 and/or to any suitable device or component in communication with system control logic 908.

System control logic 908 for one embodiment may include one or more memory controller(s) to provide an interface to system memory 912. System memory 912 may be used to load and store data and/or instructions, for example, for system 900. In one embodiment, system memory 912 may include any suitable volatile memory, such as suitable dynamic random access memory (“DRAM”), for example.

System control logic 908, in one embodiment, may include one or more input/output (“I/O”) controller(s) to provide an interface to NVM/storage 916 and communications interface(s) 920.

NVM/storage 916 may be used to store data and/or instructions, for example. NVM/storage 916 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example.

The NVM/storage 916 may include a storage resource physically part of a device on which the system 900 is installed or it may be accessible by, but not necessarily a part of, the device. For example, the NVM/storage 916 may be accessed over a network via the communications interface(s) 920.

System memory 912 and NVM/storage 916 may include, in particular, temporal and persistent copies of PS-aware planogram display logic 924. The PS-aware planogram display logic 924 may include instructions that when executed by at least one of the processor(s) 904 result in the system 900 practicing one or more of the PS-aware planogram-display related operations described above. In some embodiments, the PS-aware planogram display logic 924 may additionally/alternatively be located in the system control logic 908.

Communications interface(s) 920 may provide an interface for system 900 to communicate over one or more network(s) and/or with any other suitable device. Communications interface(s) 920 may include any suitable hardware and/or firmware, such as a network adapter, one or more antennas, a wireless interface, and so forth. In various embodiments, communication interface(s) 920 may include an interface for system 900 to use NFC, optical communications (e.g., barcodes), BlueTooth or other similar technologies to communicate directly (e.g., without an intermediary) with another device.

For one embodiment, at least one of the processor(s) 904 may be packaged together with system control logic 908 and/or PS-aware planogram display logic 924. For one embodiment, at least one of the processor(s) 904 may be packaged together with system control logic 908 and/or PS-aware planogram display logic 924 to form a System in Package (“SiP”). For one embodiment, at least one of the processor(s) 904 may be integrated on the same die with system control logic 908 and/or PS-aware planogram display logic 924. For one embodiment, at least one of the processor(s) 904 may be integrated on the same die with system control logic 908 and/or PS-aware planogram display logic 924 to form a System on Chip (“SoC”).

The following paragraphs describe examples of various embodiments. In various embodiments, an apparatus for displaying a planogram may include one or more computer processors. The apparatus may also include an image acquisition module which may be configured to be operated by the one or more computer processors to the acquire an image of a presentation structure. The apparatus may also include a display module configured to be operated by the one or more computer processors to display a planogram of an intended presentation of items at the presentation structure contemporaneously with acquisition of the acquired image. The display of the planogram may be based at least in part on the acquired image.

In various embodiments, the apparatus may also include a display portion. In various embodiments, the display module may be further configured to be operated by the one or more computer processors to display the acquired image on the display portion contemporaneously with acquisition of the acquired image. The display module may be further configured to display the planogram through augmentation of the displayed image with the planogram. In various embodiments, the display module may be further configured to be operated by the one or more computer processors to augment the displayed image with the planogram via generation of a composite image through placement of a partially-transparent version of the planogram on top of the acquired image.

In various embodiments, the apparatus may further include a planogram preparation module configured to be operated by the one or more computer processors. The planogram preparation module may be configured to analyze the acquired image to identify the presentation structure. The planogram preparation module may be configured to select the planogram of the intended presentation of items at the presentation structure for display based at least in part on identification of the presentation structure. In various embodiments, the planogram preparation module may be further configured to be operated by the one or more computer processors to analyze the acquired image through analysis of one or more markers visible in the image.

In various embodiments, the planogram preparation module may be configured to be operated by the one or more computer processors to identify the presentation structure through identification of a location for the presentation structure based on the analysis of the one or more markers. In various embodiments, the one or more markers may be attached to the presentation structure. In various embodiments, the one or more markers may include micro digital signage.

In various embodiments, the apparatus may further comprise one or more orientation and/or position sensors. In various embodiments, the planogram preparation module may be further configured to be operated by the one or more computer processors to receive data from the one or more orientation and/or position sensors. In various embodiments, the planogram preparation module may be further configured to identify the presentation structure based at least in part on the received data from one or more orientation and/or position sensors.

In various embodiments, the planogram preparation module may be further configured to be operated by the one or more computer processors to augment the displayed image with the planogram via determination of an orientation and/or position of the acquired image relative to the apparatus and modification of the planogram based on the orientation and position of the acquired image. In various embodiments, the apparatus may further comprise one or more orientation and/or position sensors. In various embodiments, the planogram preparation module may be further configured to be operated by, the one or more computer processors to determine orientation and position of the acquired image through analysis of data received from the one or more orientation and/or position sensors. In various embodiments, the orientation and/or position sensors may include one or more of a GPS sensor, an accelerometer, or a compass. In various embodiments, the planogram preparation module may be further configured to be operated by the one or more computer processors to determine orientation and position of the acquired image through analysis of one or more location indicators visible in the acquired image.

In various embodiments, the planogram preparation module may be further configured to be operated by the one or more computer processors to acquire the planogram from a remote storage. In various embodiments, the planogram preparation module may be further configured to be operated by the one or more computer processors to store the planogram on the apparatus. In various embodiments, the presentation structure may include a shelf. In various embodiments, the apparatus may further include a camera. In various embodiments, the image acquisition module may be further configured to be operated by the one or more computer processors to acquire the image via the camera. In various embodiments, the apparatus may further comprise a display portion located on an opposite side of the apparatus from the camera. In various embodiments, the planogram preparation module may be further configured to be operated by the one or more computer processors to display the planogram on the display portion.

In various embodiments, the image acquisition module may be further configured to acquire a second image of a presentation structure. In various embodiments, the display module may be further configured to display the planogram in a modified fashion contemporaneously with acquisition of the acquired second image, based at least in part on the second acquired image. In various embodiments, the image planogram display system may be further configured to repeat acquisition of images. In various embodiments, the display module may be further configured to repeat display of the planogram in one or more modified fashions based at least in part on the acquired images.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more non-transitory computer-readable storage media having instructions embodied therein that are configured, in response to execution by a computing device, to cause the computing device to operate a planogram display system to:
acquire an image of a presentation structure; and
contemporaneously with acquisition of the acquired image, display a planogram of an intended presentation of items at the presentation structure, based at least in part on the acquired image.

2. The one or more computer-readable media of claim 1, wherein the planogram display system is further to:
contemporaneously with acquisition of the acquired image, display the acquired image on a display portion of the computing device; and
display the planogram through augmentation of the displayed image with the planogram.

3. The one or more computer-readable media of claim 2, wherein the planogram display system is further to augment the displayed image with the planogram via placement of a partially-transparent version of the planogram on top of the acquired image.

4. The one or more computer-readable media of claim 1, wherein the planogram display system is further to:
analyze the acquired image to identify the presentation structure; and
select the planogram of the intended presentation of items at the presentation structure for display based at least in part on identification of the presentation structure.

5. The one or more computer-readable media of claim 4, wherein the planogram display system is further to cause the computing device to analyze the acquired image through analysis of one or more markers visible in the image.

6. The computer-readable media of claim 5, wherein the planogram display system is further to cause the computing device to identify the presentation structure through identification of a location for the presentation structure based on the analysis of the one or more markers.

7. The one or more computer-readable media of claim 5, wherein the one or more markers are attached to the presentation structure.

8. The one or more computer-readable media of claim 7, wherein the one or more markers indicators comprise micro digital signage.

9. The one or more computer-readable media of claim 4, wherein the planogram display system is further to:
receive data from one or more orientation and/or position sensors of the computing device; and
identify the presentation structure based at least in part on the received data from one or more orientation and/or position sensors of the computing device.

10. The one or more computer-readable media of claim 4, wherein the planogram display system is further to cause the computing device to augment the displayed image with the planogram via:
determination of an orientation and/or position of the acquired image relative to the computing device; and
modification of the planogram based on the orientation and position of the acquired image.

11. The one or more computer-readable media of claim 10, wherein the planogram display system is further to determine orientation and position of the acquired image through analysis of data received from one or more orientation and/or position sensors of the computing device.

12. The one or more computer-readable media of claim 11, wherein the orientation and/or position sensors comprise one or more of: a GPS sensor, an accelerometer, and a compass.

13. The one or more computer-readable media of claim 10, wherein the planogram display system is further to determine orientation and position of the acquired image through analysis of one or more location indicators visible in the acquired image.

14. The one or more computer-readable media of claim 4, wherein the planogram display system is further to acquire the planogram from a remote storage.

15. The one or more computer-readable media of claim 4, wherein the planogram display system to further store the planogram on the computing device.

16. The one or more computer-readable media of claim 4, wherein the presentation structure comprises a shelf.

17. The one or more computer-readable media of claim 4, wherein the planogram display system is further to acquire the image via a camera of the computing device.

18. The one or more computer-readable media of claim 17, wherein the planogram display system is further to display the planogram on a display portion of the computing device, and the camera of the computing device is located on an opposite side of the computing device from the display portion of the computing device.

19. The one or more computer-readable media of claim 1, wherein the planogram display system is further to:
acquire a second image of a presentation structure; and
contemporaneously with acquisition of the acquired second image, modify display of the planogram, based at least in part on the second acquired image.

20. The one or more computer-readable media of claim 19, wherein the planogram display system is further to repeat acquisition of images and modification of display of the planogram based at least in part on the acquired images.

21. An apparatus for displaying a planogram, the apparatus comprising:
one or more computer processors;
an image acquisition module configured to be operated by the one or more computer processors to the acquire an image of a presentation structure; and
a display module configured to be operated by the one or more computer processors to display a planogram of an intended presentation of items at the presentation structure contemporaneously with acquisition of the acquired image, based at least in part on the acquired image.

22. The apparatus of claim 21, wherein:
the apparatus further comprises a display portion; and
the display module is further configured to be operated by the one or more computer processors to:
display the acquired image on the display portion contemporaneously with acquisition of the acquired image; and
display the planogram through augmentation of the displayed image with the planogram.

23. (canceled)

24. The apparatus of any claim 21, further comprising a planogram preparation module configured to be operated by the one or more computer processors to:
analyze the acquired image to identify the presentation structure; and
select the planogram of the intended presentation of items at the presentation structure for display based at least in part on identification of the presentation structure.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. The apparatus of any of claim 21, wherein:
the image acquisition module is further configured to acquire a second image of a presentation structure; and
the display module is further configured to display the planogram in a modified fashion contemporaneously with acquisition of the acquired second image, based at least in part on the second acquired image.

40. (canceled)

41. A computer-implemented method for displaying a planogram, the method comprising:
acquiring, by a computing device, an image of a presentation structure; and
contemporaneously with acquisition of the acquired image, displaying, by the computing device, a planogram of an intended presentation of items at the presentation structure, based at least in part on the acquired image.

42. The method of claim 41, further comprising:
contemporaneously with acquisition of the acquired image, displaying, by the computing device, the acquired image on a display portion of the computing device; and
wherein displaying the planogram comprises augmenting the displayed image with the planogram.

43-60. (canceled)
